(19) United States
(12) Patent Application Publication
(10) Pub. No.: US 2020/0393807 A1
(43) Pub. Date: Dec. 17, 2020

(54) SYSTEM AND METHOD FOR DETECTING DEVICE REARRANGEMENT IN MANUFACTURING FIELD

(71) Applicant: Hitachi, Ltd., Tokyo (JP)

(72) Inventors: Nobuyuki Muranaka, San Jose, CA (US); Daisuke Ito, Cupertino, CA (US)

(21) Appl. No.: 16/440,767

(22) Filed: Jun. 13, 2019

(51) Int. Cl. G05B 19/05; H04L 29/06; H04L 29/08

(52) U.S. Cl. CPC G05B 19/058; H04L 67/2842; H04L 63/1425; G05B 19/052

(57) ABSTRACT

A device rearrangement detection system and method are disclosed. Example implementations maintain the structure of assets (e.g., manufacturing machines, programming logic controllers, higher programming logic controllers), managed in manufacturing field as stored in the information technology (IT) system to the latest version should rearrangement occur. Such rearrangement detection can operate in an environment involving isolated networks.

### BACKGROUND

### Field

The present disclosure relates to Internet of Things (IoT) systems, and more specifically, to detecting rearrangements of manufacturing machines on a factory floor deploying IoT solutions.

### Related Art

When applying IoT solutions to the manufacturing field, an information technology (IT) server collects the data that represents behavior of manufacturing machines on the field via Programmable Logic Controller (PLC).

However, the IT server will retrieve the data for different manufacturing machines via the same PLC when a KAIZEN event occurs. During a KAIZEN event, the location and order of deployment of manufacturing machines can be changed, which would also cause a change to the connections between PLCs and manufacturing machines. Such events are referred to herein as ‘rearrangement’. Further, the IoT system configured to manage the manufacturing field and the IT servers are located on isolated networks that are siloed from each other, so administrators of the IT server cannot obtain the rearrangement data. Thus, there is a need to detect when rearrangements occur from the IT server side.

In a related art implementation, there are systems and methods for discovery and mapping of a network topology which involves network topology discovery, classification on network devices, identification of silent devices, fingerprinting and mapping the network map including PLCs.

### SUMMARY

Aspects of the present disclosure can include a method for detecting changes in a manufacturing field system that involves a first network processing data regarding one or more manufacturing machines, and a second network managing a plurality of programmable logic controllers (PLCs) connected to the one or more manufacturing machines, the method including monitoring the plurality of PLCs through the second network, each of the PLCs associated with the one or more manufacturing machines; and for the monitoring indicating a change in the second network, the change involving one or more of a different manufacturing machine associated with one of the plurality of PLCs, or a change in an order of execution of the one or more manufacturing machines for one of the plurality of PLCs, updating a hierarchy of the manufacturing field system based on the change.

Aspects of the present disclosure can include means for detecting changes in a manufacturing field system that involves a first network processing data regarding one or more manufacturing machines, and a second network managing a plurality of programmable logic controllers (PLCs) connected to the one or more manufacturing machines, the means including means for monitoring the plurality of PLCs through the second network, each of the PLCs associated with the one or more manufacturing machines; and for the monitoring indicating a change in the second network, the change involving one or more of a different manufacturing machine associated with one of the plurality of PLCs, or a change in an order of execution of the one or more manufacturing machines for one of the plurality of PLCs, means for updating a hierarchy of the manufacturing field system based on the change.

Aspects of the present disclosure can include a computer program for detecting changes in a manufacturing field system that involves a first network processing data regarding one or more manufacturing machines, and a second network managing a plurality of programmable logic controllers (PLCs) connected to the one or more manufacturing machines, the computer program including instructions for monitoring the plurality of PLCs through the second network, each of the PLCs associated with the one or more manufacturing machines; and for the monitoring indicating a change in the second network, the change involving one or more of a different manufacturing machine associated with one of the plurality of PLCs, or a change in an order of execution of the one or more manufacturing machines for one of the plurality of PLCs, updating a hierarchy of the manufacturing field system based on the change. The instructions can be stored on a non-transitory computer readable medium and configured to be executed by one or more processors.

Aspects of the present disclosure involve an apparatus configured for detecting changes in a manufacturing field system including a first network processing data regarding one or more manufacturing machines, and a second network managing a plurality of programmable logic controllers (PLCs) connected to the one or more manufacturing machines, the apparatus communicatively coupled to the second network, the apparatus involving a processor, configured to monitor the plurality of PLCs through the second network, each of the PLCs associated with the one or more manufacturing machines; and for the monitoring indicating a change in the second network, the change involving one or more of a different manufacturing machine associated with one of the plurality of PLCs, or a change in an order of execution of the one or more manufacturing machines for one of the plurality of PLCs, update a hierarchy of the manufacturing field system based on the change.

### BRIEF DESCRIPTION OF DRAWINGS

FIG. 1 illustrates a system diagram of an example rearrangement detection system in accordance with an example implementation.

FIG. 2 illustrates an example sequence for detecting the rearrangements in accordance with an example implementation.

FIG. 3 illustrates an example flow process of the PLC Status Monitor in accordance with an example implementation.

FIG. 4 illustrates an example of the PLC Status Repository table in accordance with an example implementation.

FIG. 5 illustrates an example flow process of DPI Monitor in accordance with an example implementation.

FIG. 6 illustrates an example of DPI Monitoring Result Repository table in accordance with an example implementation.

FIG. 7 illustrates an example flow process of Network Monitor in accordance with an example implementation.

FIG. 8 illustrates an example of Network Monitoring Result Repository table in accordance with an example implementation.

FIG. 9 illustrates an example of Arrangement Pattern Repository table in accordance with an example implementation.

FIG. 10 illustrates an example of Rearrangement Detector in accordance with an example implementation.

FIGS. 11(a) and 11(b) illustrate examples of Rearrangement Notification Message table in accordance with an example implementation.

FIG. 12 illustrates an example of a diagram of Asset Repository in accordance with an example implementation.

FIG. 13 illustrates an example flow process of Asset Manager in accordance with an example implementation.

FIG. 14 illustrates an example computing environment with an example computer device suitable for use in example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations of a rearrangement detection method and system are described as follows.

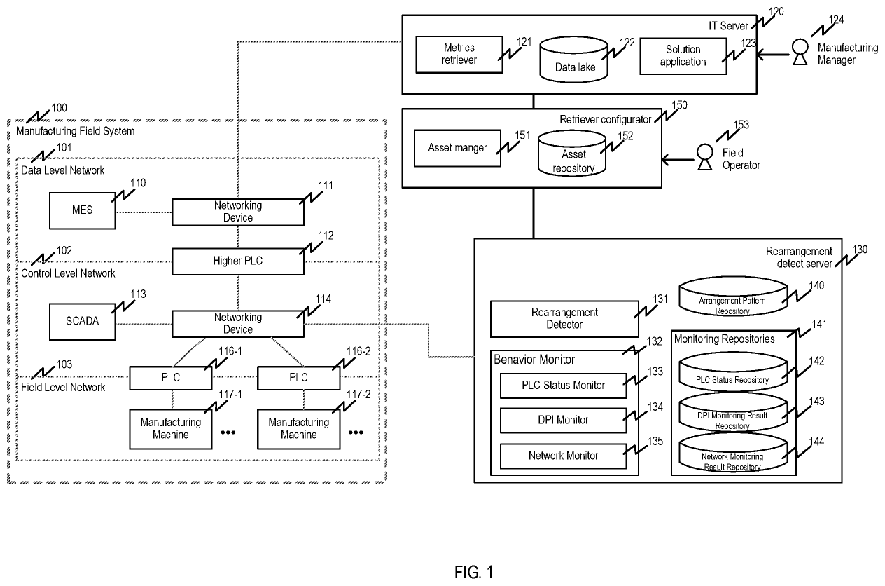

FIG. 1 illustrates a system diagram of an example rearrangement detection system in accordance with an example implementation. In a manufacturing field system 100, there can be a data level network 101, a control level network 102 and a field level network 103 for managing the manufacturing areas in the manufacturing field. The data level network 101 can be constructed by Ethernet and internet protocol (IP) through networking device 111, and provides data to the IT server 120. The Higher PLC 112 provides data that is processed by Manufacturing Execution Systems 110 (MES), which conducts analytics on the received data and provides results of the manufacturing field system, such as productivity metrics and so on in accordance with the desired implementation.

Control level network 102 can be constructed by Ethernet and Industrial Ethernet protocols that utilize special features to facilitate industrial implementations that require real-time, high availability data flow, unlike the IT protocol. Examples of specifications for control level network 102 can include CC-Link, PROFINET, EtherNet/IP, EtherCAT, and so on in accordance with the desired implementation. In the control network 102, topology such as Star, Ring, Line, and so on are used, unlike a normal IT environment. The networking device 114 provides data to the rearrangement detect server 130 and to Higher PLC 112 based on data processing conducted by the supervisory control and data acquisition (SCADA) and receives data from PLCs 116-1, 116-2.

Field level network 103 can involve a Serial Cable such as RS-485 or Ethernet and Industrial Ethernet protocol. In example implementations, the Industrial Ethernet protocol for the field level network 103 typically guarantees real-time communication more strictly. Examples of specifications for field level network 103 can involve CC-Link, PROFIBUS, DeviceNet, and so on in accordance with the desired implementation. In example implementations, a line topology is used in field level network 103 to avoid signal influence. Field level network 103 involves the assets such as manufacturing machine 117-1, 117-2, and their corresponding PLC 116-1, 116-2. IT Server 120 can involve a metrics retriever 121 which retrieves productivity data from MES 110 in data level network 101 and PLCs 116 in control level network 102, and store that data to data lake 122. Then, the solution application 123 retrieves and edits the data lake 122 to generate key performance indicators (KPIs) that is analyzed by the manufacturing manager 124.

Retriever configurator 150 can involve an asset repository 152 which stores information of the assets in the manufacturing field system 100. The field operator 153 or rearrangement detect server 130 issues instructions to the asset manager 151, whereupon the asset manager 151 edits information stored in asset repository 152. That information is utilized for generating KPIs, because that information indicates what data from PLC 116-1, 116-2 corresponds to which behavior of manufacturing machine 117-1, 117-2. The data from PLC 116-1, 116-2 includes a data set such as PLC ID, metrics and value (e.g. PLC ID#1, LotCount is 1000).

In the system as illustrated in FIG. 1, there is a first network involving the manufacturing field system 100 and the IT server 120, which communicate through networking device 111 on the data level network 101. The first network involves the PLCs such as higher PLC 112. The IT Server 120 manages data through the first network and stores the data into data lake 122 for processing, and provides the processed results to the retriever configurator 150. The field operator 133 manages the retriever configurator 150 based on the results of the IT server 120.

There is also a second network involving the control level network 102 managed by networking device 114, that manages the underlying PLCs 116-1, 116-2. In implementations of the manufacturing field system 100, the first network is isolated from the second network, s the manufacturing field system is isolated from the outside world for security reasons and inaccessible other than by a managing server such as IT server 120. Thus, the remote field operator 133 cannot determine when changes are made to the field level network 103 if manufacturing machines 117-1, 117-2 are moved to different locations and managed by different PLCs.

To address the above problem, example implementations involve a rearrangement detect server 130 that is connected to the networking device 114 so as to be communicatively coupled to the second network. The rearrangement detect server 130 involves a rearrangement detector 131 that detects the rearrangement of assets in the manufacturing field system 100 based on the data monitored by behavior monitor 132. Behavior monitor 132 involves functions such as PLC status monitor 133, Deep Packet Inspection (DPI) monitor 134, and Network Monitor 135. Data from the behavior monitor 132 can be managed by monitoring repositories 141, which can involve the PLC status repository 142, the DPI monitoring result repository 143, and the network monitoring result repository 144. Rearrangement detect server 130 also maintains an arrangement pattern repository 140 for detecting arrangement patterns. By analyzing network data, PLC status, and DPI from networking device 114, example implementations described herein can thereby device when a change in the field level network 103 has occurred without needing direct access to PLC 116-1, PLC 116-2, or manufacturing machine 117-1, 117-2. The rearrangement detect server 130 can generate messages to the retriever configurator 150 to provide updates as to the hierarchy and underlying structure of the manufacturing field system 100, while maintaining the isolation between the first network and the second network so as to protect access to the PLC 116-1, 116-2, and manufacturing machines 117-1, 117-2 from unauthorized devices.

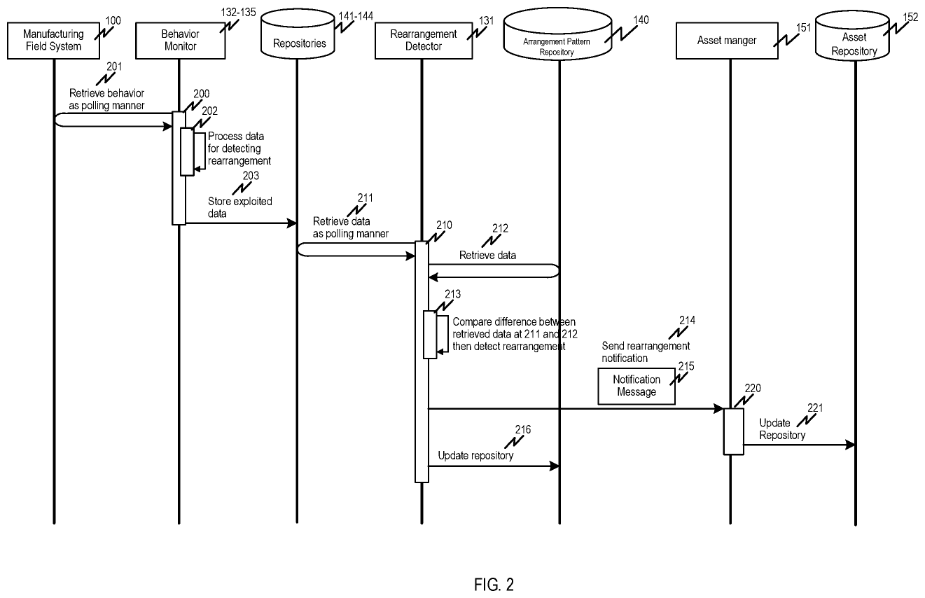

FIG. 2 illustrates an example sequence for detecting the rearrangements in accordance with an example implementation. Behavior monitor 132 executes a process 200 involving retrieving behavior data from the manufacturing field system 100 in a polling matter at 201 and processing the data for detecting rearrangements of the assets in the manufacturing field system 100 at 202. At 203, the data processed by the behavior monitor 132 is stored in the repository 141.

The rearrangement detector 131 executes a process 210 involving retrieving data from the repository 141 in a polling manner at 211, retrieving data from the arrangement pattern repository 140 at 212, comparing the difference between the data retrieved from the repository 141 and the arrangement pattern 140 at 213, sending a notification message 215 as applicable at 214, and update the repository 216. Through the comparison of the data retrieved from the repository 141 and the arrangement pattern repository 140, the rearrangement detector 131 can thereby determine changes in configurations to the underlying assets of the manufacturing field system 100.

The asset manager 151 receives a notification message 215 and executes a process 220 to update the asset repository 152 at 221 based on the notification message 215. Through the notification messages 215, the asset manager 151 can thereby be informed of the underlying arrangement of the assets in the manufacturing field system 100 even if the asset manager 151 is on a network that is isolated from the network of the manufacturing field system 100.

In the example, behavior monitor 132 involves the three types of monitors 133, 134, 135 as described in FIG. 1, and monitoring repositories 141 involves three types of repositories 142, 143, 144 as described in FIG. 1. The type of monitor that is used can depend on the environment of the manufacturing field system 100. So, all monitor and repository may be not used in that case.

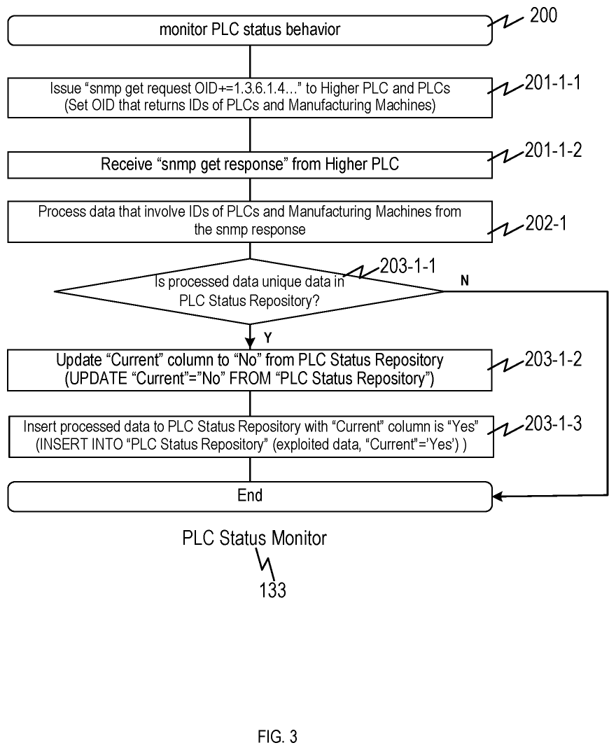

FIG. 3 illustrates an example flow process of the PLC Status Monitor 133 in accordance with an example implementation. Specifically, the flow of FIG. 3 is an example of the process 200 utilized by the PLC Status Monitor 133 as part of the behavior monitor 132 process to monitor the status of the PLCs, along with example steps for performing the processes 201, 202 and 203. At 201-1-1, the PLC status monitor 133 issues an “snmp get request OID+=1.3.6.1.4 . . . ” to higher PLC 112 and PLCs 116-1, 116-2. In other words, the snmp get request sets an object identifier (OID) that returns IDs of PLCs 116-1, 116-2 and corresponding manufacturing machines 117-1, 117-2. At 201-1-2, the PLC status monitor 133 receives the snmp get response from the higher PLC 112. At 202-1, the PLC status monitor 133 processes data that involve IDs of PLCs 116-1, 116-2 and manufacturing machines 117-1, 117-2 from the snmp response. At 203-1-1, a determination is made by the PLC status monitor 133 as to whether the processed data is unique data in the PLC Status Repository 142 (e.g., record does not exist). If not (N) then the flow ends as no changes have been made to the PLC, otherwise (Y) the flow proceeds to 203-1-2.

At 203-1-2, the current column in the PLC status repository 142 is updated to “No”. At 203-1-3, the processed data is inserted into the PLC status repository 142, and the current column is set to yes to indicate the update. As illustrated in FIG. 3, PLC Status Monitor 133 issues some management protocol to Higher PLC 112 and PLCs 116-1, 116-2. In this example implementation, PLC Status Monitor 133 uses SNMP protocol. However, PLC Status Monitor 133 may use another protocol such as LLDP (Link Layer Discovery Protocol), SLMP (Seamless Message Protocol), a vendor specific protocol and so on in accordance with the desired implementation.

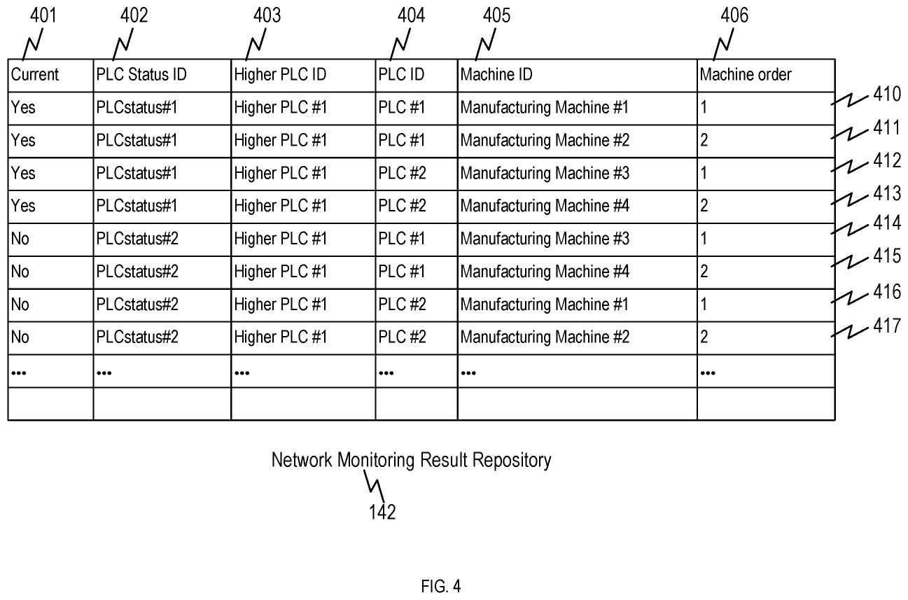

FIG. 4 illustrates an example of the PLC Status Repository 142 table in accordance with an example implementation. In the example entries in the network monitoring result repository 142, there is a current column 401 indicating whether the entry reflects the current status of the PLC, the PLC status ID 402, the Higher PLC ID 403, the PLC ID 404, the machine ID 405 and the machine order 406 (e.g., order of execution of the machine for a manufacturing process). Example entries 410, 411, 412, 413, 414, 414, 416, 417 illustrate the status of the manufacturing field system 100. For example, in the previous configuration of the manufacturing field system 100 (current column 401 of no), entries 414, 415, 416, and 417 indicated that the PLCs were operating under PLCstatus#2, in which PLC#2 managed manufacturing machines #1 and #2 to execute in a particular order, and PLC#1 managed manufacturing machines #3 and #4 to execute in a particular order. The current configuration of the manufacturing field system 100 (current column 401 of Yes) indicates that the PLCs are operating under PLCstatus#1 in which PLC#1 manages manufacturing machines #1 and #2 in a particular order, and PLC#2 manages manufacturing machines #3 and #4 in a particular order. Through this example implementation, it can be shown that manufacturing machines #1 and #2 had their locations switched with manufacturing machines #3 and #4 between the transition from PLCStatus#2 to PLCstatus#1.

By using the management protocol, PLC Status Monitor 133 can get the Machine order 146 that indicates the order within a PLC. Machine order 406 is presented in the data structure of the response of management protocol or specific ID (e.g. Network ID, Station ID) or so on in accordance with a desired implementation.

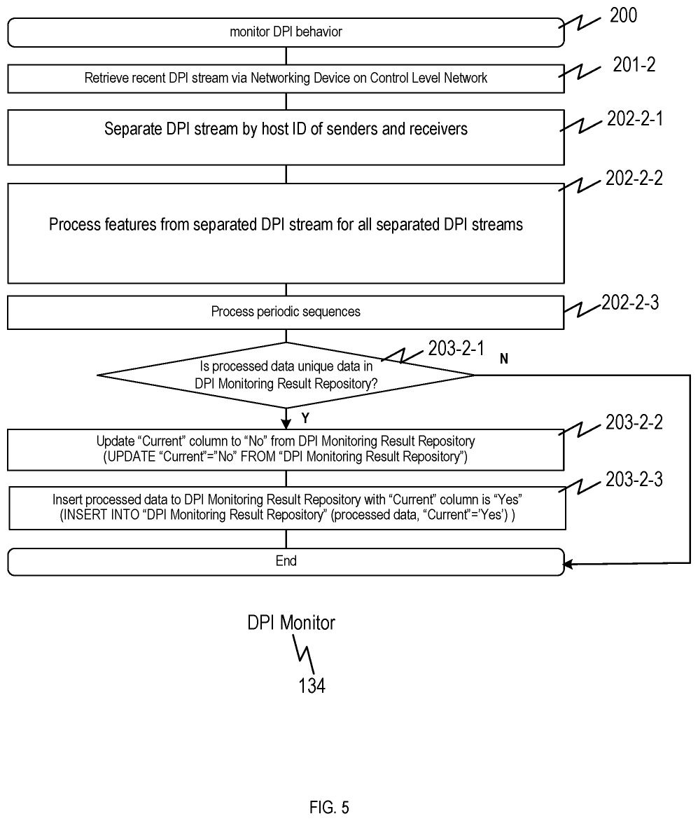

FIG. 5 illustrates an example flow process of DPI monitor 134 in accordance with an example implementation. In example implementations, DPI monitor 134 is executed during the process 200 of behavior monitor 132, and executes steps to facilitate the processes at 201, 202 and 203 as follows. At 201-2, the DPI monitor 134 retrieves the recent DPI stream via networking device 114 on control level network 102. At 202-2-1, the DPI monitor 134 separates the DPI stream by the host ID of the senders and receivers. In an example execution of this process, DPI monitor 134 can be configured to, for all combinations of host ID of senders and receivers apply filter “host ID of sender && host ID of receiver” in accordance with the desired implementation. Depending on the desired implementation, IP address or MAC address can be used as the host ID.

At 202-2-2, the DPI monitor 134 processes the features from the separated DPI stream for all separated DPI streams. The processing of the features can be conducted as follows: for each of the separated DPI streams, apply filter “udp contains POSITION” apply filter “udp contains CONTROL” apply filter “udp contains SLOTON”. At 202-2-3, the DPI Monitor 134 processes periodic sequences. At 203-2-1, a determination is made as to whether the processed data is data that is unique to the entries in the DPI monitoring result repository 143. If not (N) then the flow ends, otherwise (Y) the current column is updated to No in the DPI monitoring result repository 143 to indicate that the entries do not reflect the present architecture of the manufacturing field system 100. At 203-2-3, the processed data is inserted into the DPI monitoring result repository 143 with the current column field set to Yes to indicate that the entries reflect the present architecture of the manufacturing field system 100.

In example implementations, DPI Monitor 134 uses a mirroring port on networking device 114 when DPI Monitor 134 captures packets in order to avoid affecting the control level network 102. The DPI monitor 134 takes advantage of how higher PLC 112 and PLC 116-1, 116-2 and manufacturing machines 117-1, 117-2 communicate periodically because manufacturing machines may move or change routines periodically to make products stably.

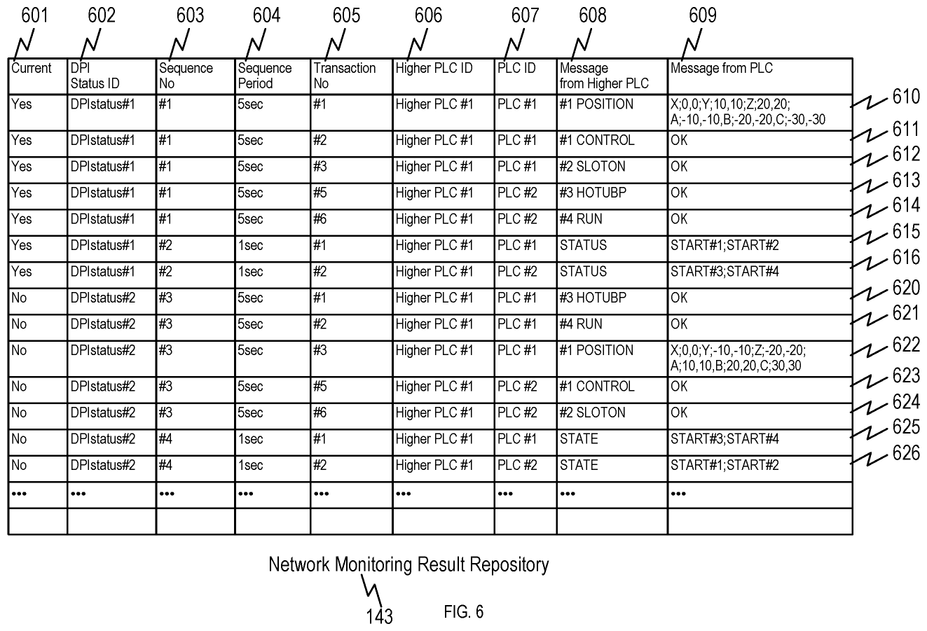

FIG. 6 illustrates an example of DPI Monitoring Result Repository 143 table in accordance with an example implementation. The fields for the entries of DPI monitoring result repository 143 can include current status 601 to indicate if the entry reflects the current status of the manufacturing field system 100, DPI status ID 602, sequence number 603, sequence period 604, transaction number 605, higher PLC ID 606, PLC ID 607, message from higher PLC 608 and message from PLC 609. For example, entries 610, 611, 612, 613, 614, 615, and 616 have a current field of Yes, indicating that those entries reflect the current architecture in the manufacturing field system 100. Entries 620, 621, 622, 623, 624, 625, 626 with a current field of No indicate a previous architecture.

In this example, one DPI status involves a plurality of sequences. One sequence involves a plurality of transactions. By analyzing transactions, DPI Monitor 134 can recognize not only the behavior of each manufacturing machine 117-1, 117-2 under PLC 116-1. 116-2 but also the order of each manufacturing machine 117-1, 117-2 under PLC 116-1, 116-2.

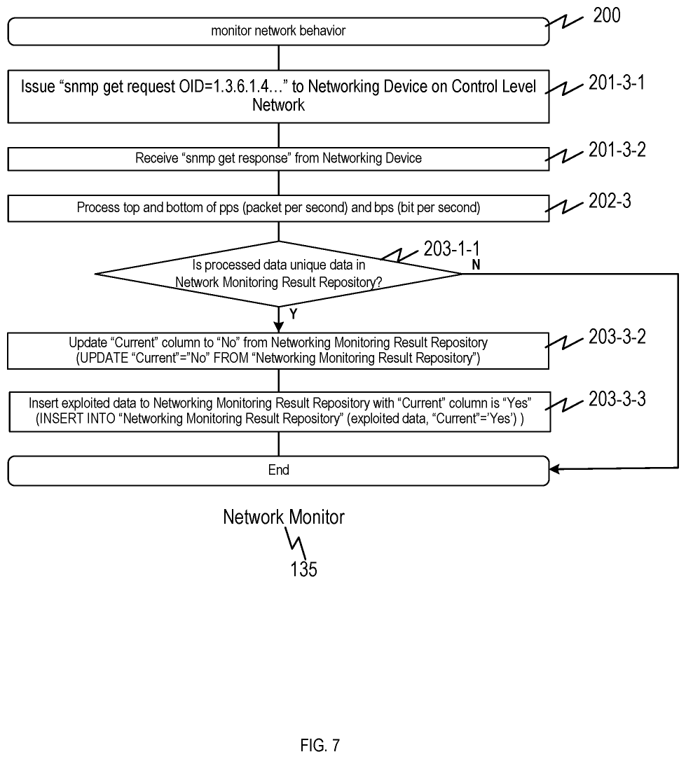

FIG. 7 illustrates an example flow process of Network Monitor 135 in accordance with an example implementation. The network monitor 135 can be executed during process 200 of the behavior monitor 132 and facilitates the execution of the processes of 201, 202 and 203 through the steps as follows. At 201-3-1, the network monitor 135 issues a “snmp get request OID=1.3.6.1.4 . . . ” to networking device 114 on control level network 102 a plurality of times. That is, the network monitor sets the OID that returns packet number and traffic amount on networking device 114. At 201-3-2, the network monitor receives an snmp get response from the networking device 114. At 202-3, the snmp get response is processed for the top and bottom packet per second and bits per second values. At 203-1-1 the network monitor 135 determines if the processed data represent data that is unique in view of the entries in the Network Monitoring Result Repository 144. If not (N), then the flow ends as the network of the manufacturing field system 100 has not changed. Otherwise (Y), the flow proceeds to 203-3-2, wherein the network monitor 135 updates the current column of the entries of the network monitoring result repository 144 to be No to indicate that they no longer reflect the current architecture of the manufacturing field system 100. At 203-3-3, the processed data is inserted into the networking monitoring result repository 144 with the current field set to Yes, which indicates that the processed data reflects the present architecture of the manufacturing field system 100.

In this example, network monitor 135 uses SNMP protocol to obtain data from networking device 114, as snmp is a common protocol to which the networking device 114 can provide the number of packets and bits in response. However, other protocols may be utilized in accordance with the desired implementation.

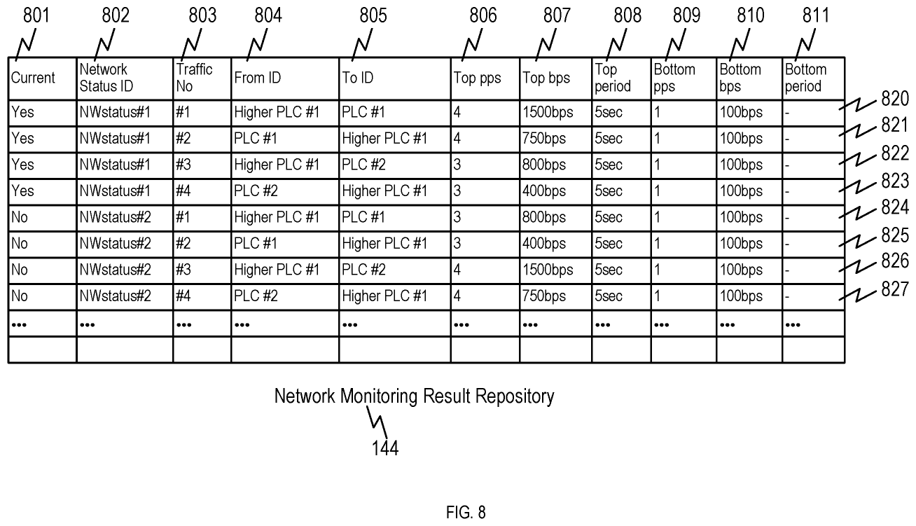

FIG. 8 illustrates an example of Network Monitoring Result Repository 144 table in accordance with an example implementation. The fields of network monitoring result repository 144 can include fields for current status 801 which indicates if the entry reflects the current architecture, the network status ID 802, the traffic number 803, the from ID 804 indicating the source of the traffic, the to ID 805 indicating the destination of the traffic, the top number of packets per second 806, the top number of bits per seconds 807, the top period 808, the bottom packets per second 809, the bottom bits per second 810 and the bottom period 811. For example, entries 820, 821, 822, 823 reflect the current status of the manufacturing field system 100 as the current column indicates Yes, whereas entries 824, 825, 826, and 827 reflect a prior status of the manufacturing field system 100 as the current column indicates No. In example implementations described herein, the information associated with throughput information can involve any information from the fields of the network monitoring result repository, in singular or in combination.

With data in network monitoring result repository 144, network monitor 135 can recognize behavior of manufacturing machines 117-1, 117-2 under the PLC 116-1, 116-2, but may not recognize the order of manufacturing machines 117-1, 117-2 under the PLC 116-1, 116-2.

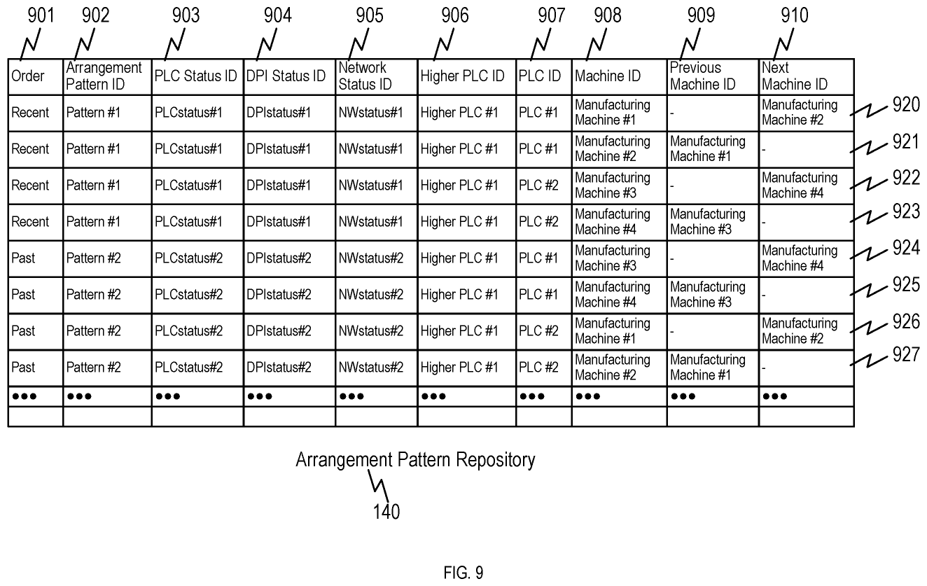

FIG. 9 illustrates an example of Arrangement Pattern Repository 140 table in accordance with an example implementation. Arrangement pattern repository 140 manages entries that can include fields for the order 901, the arrangement pattern ID 902, the PLC Status ID 903, the DPI status ID 904, the network status ID 905, the higher PLC ID 906, the PLC ID 907, the machine ID 908, the previous machine ID 909, and the next machine ID 910. Entries 920, 921, 922, and 932 indicate arrangement patterns that were recently implemented in the manufacturing field system 100. Entries 924, 925, 926, and 927 indicate arrangement patterns that were implemented in the past for the manufacturing field system 100. In the example, one Arrangement Pattern ID 902 has at least one PLC Status ID 903 or DPI Status ID 904 or Network Status ID 905. Further, one Arrangement Pattern ID 902 has at least one relation between Higher PLC ID 906 and PLC ID 907 and Machine ID 908. In addition, one Arrangement Pattern ID 902 may have a Previous Machine ID 909 and Next Machine ID 910, but that is optional depending on the situation. When Rearrangement Detector 131 can retrieve PLC Status ID 903, each Previous Machine ID 909 and Next Machine ID 910 can be filled.

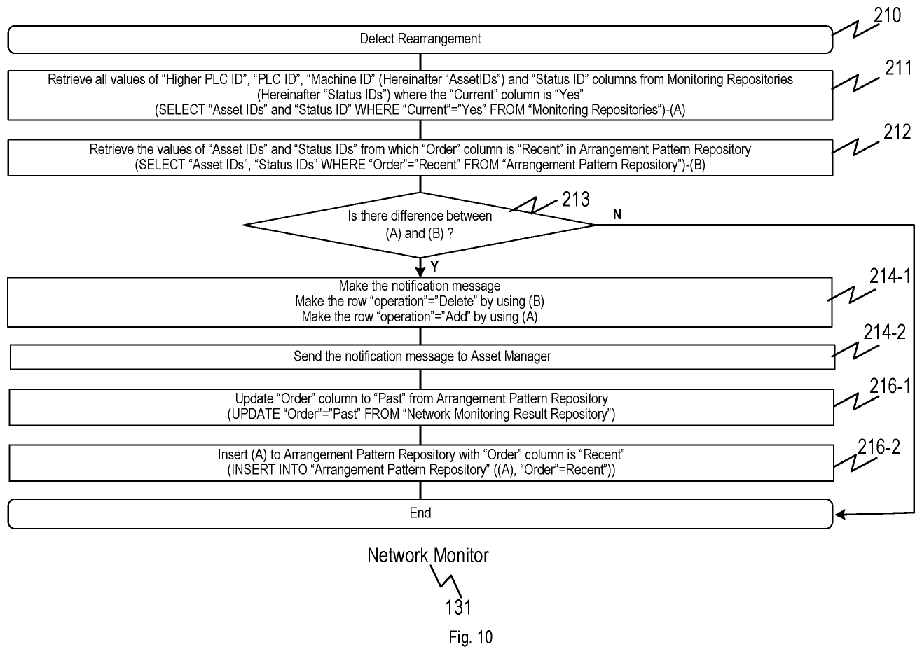

FIG. 10 illustrates an example of Rearrangement Detector 131 in accordance with an example implementation. Specifically, FIG. 10 illustrates the process 210 executed by Rearrangement Detector 131 to detect changes in the manufacturing field system 100.

At 211, the rearrangement detector 131 retrieves all values of “Higher PLC ID”, “PLC ID”, “Machine ID” (Hereinafter “AssetIDs”) and “Status ID” columns from Monitoring Repositories 141-144 (Hereinafter “Status IDs”) where the “Current” column is “Yes” to obtain the current configuration of the manufacturing field system 100. The command executed can be, for example, SELECT “Asset IDs” and “Status ID” WHERE “Current”=“Yes” FROM “Monitoring Repositories”. Denote the obtained AssetIDs and Status IDs as (A).

At 212, the rearrangement detector 131 retrieves the values of “Asset IDs” and “Status IDs” from which the “Order” column is “Recent” in Arrangement Pattern Repository 140. The command execute can be, for example, SELECT “Asset IDs”, “Status IDs” WHERE “Order”=“Recent” FROM “Arrangement Pattern Repository”. Denote the obtained values as (B)

At 213, the rearrangement detector 131 determines if there is a difference between (A) and (B). If not (N) then the arrangement pattern repository 140 reflects the most recent configuration of the manufacturing field system 100, and the flow ends. Otherwise (Y), the configuration is different from what is noted in the arrangement pattern repository 140 and the flow proceeds to 214. The rearrangement detector 131 executes the process 214 through the steps as follows.

At 214-1, the rearrangement detector 131 creates a notification message 215, which involves the following commands. The commands include making the row “operation”=“Delete” for the values associated with (B), and making the row “operation”=“Add” for (A).

At 214-2, the rearrangement detector 131 sends the notification message 215 to Asset Manager 151. The rearrangement detector 131 then executes the process 216 through the steps as follows.

At 216-1, the rearrangement detector 131 updates the “Order” column to “Past” from Arrangement Pattern Repository 140. An example of the command can be UPDATE “Order”=“Past” FROM “Network Monitoring Result Repository”. At 216-2, the rearrangement detector 131 inserts (A) to Arrangement Pattern Repository 140 with “Order” column set to “Recent”. An example of the command can be INSERT INTO “Arrangement Pattern Repository” ((A), “Order”=“Recent”).

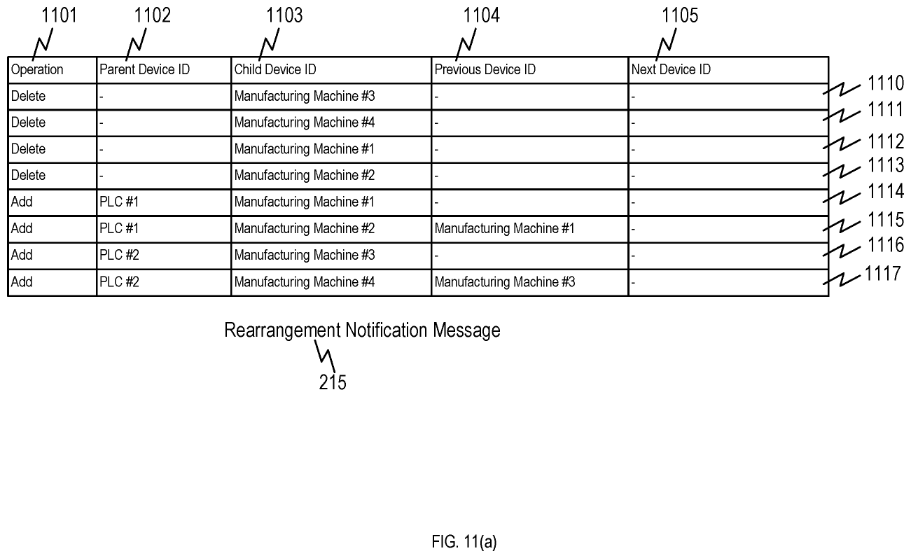

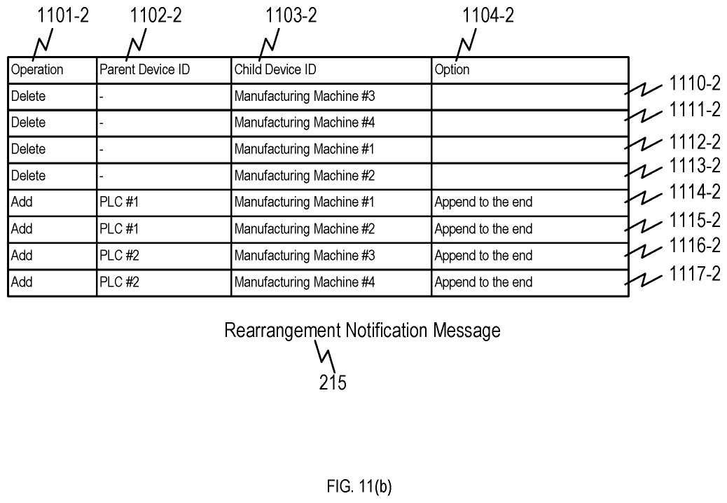

FIGS. 11(a) and 11(b) illustrate examples of Rearrangement Notification Message 215 table in accordance with an example implementation. Specifically, in situations where rearrangement detector 131 can recognize the order the manufacturing machines 117-1, 117-2 are executing, then the rearrangement detector 131 transmits messages as shown in FIG. 11(a). The fields for rearrangement notification message 215 can include operation 1101, parent device ID 1102, child device ID 1103, previous device ID 1104, and next device ID 1105. Messages 1110, 1111, 1112, and 1113 are directed to delete operations for the asset manager 151. Messages 1114, 1115, 1116, and 1117 are directed to add operations for the asset manager 151.

In situations where the rearrangement detector 131 cannot recognize the order of execution, then the rearrangement detector 131 transmits messages as shown in FIG. 11(b). The fields for such messages can include operation 1101-2, parent device ID 1102-2, child device ID 1103-2, and option 1104-2. Messages 1110-2, 1111-2, 1112-2, and 1113-2 are directed to delete operations for the asset manager 151. Messages 1114-2, 1115-2, 1116-2, and 1117-2 are directed to add operations for the asset manager 151. If Rearrangement detect server 130 can use PLC Status Monitor 133, rearrangement detector 131 can recognize the order. If not, rearrangement detector 131 may not able to recognize the order obviously.

In example implementations, asset manager 151 will execute rearrangement notification message 215 from the top sequentially. For example, from messages 1114 and 1116, there is no Previous and Next device since PLC #1 and PLC #2 has no child device. In an example implementation, rearrangement notification message 215 can include ‘Change’ operation that include ‘Delete’ and ‘Add’ operation.

Further, if rearrangement detector 131 cannot identify Child Device ID clearly, rearrangement detector 131 can also indicate that an unidentified device is under the parent device via rearrangement notification message 215 in accordance with a desired implementation.

The format of rearrangement notification message 215 can represent not only a relationship between PLC 116-1, 116-2, and manufacturing machine 117-1, 117-2, but also a relationship between higher PLC 112 and PLC 116-1, 116-2.

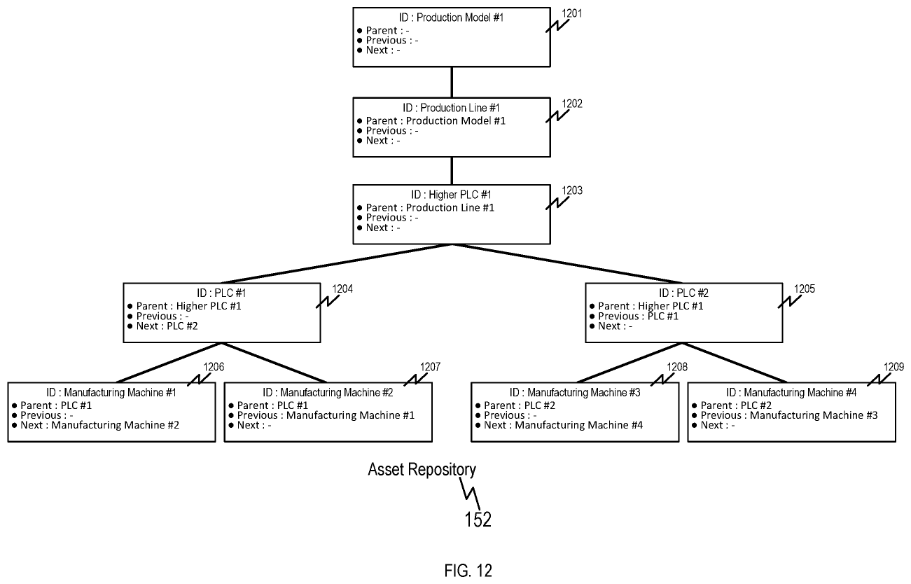

FIG. 12 illustrates an example of a diagram of asset repository 152 in accordance with an example implementation. Specifically, the asset repository 152 manages a hierarchy of the assets and PLCs on the manufacturing field system 100. In an example of the hierarchy, the production model that is being produced by the manufacturing field system 100 is the top of the hierarchy at 1201. The production model is manufactured by one or more several production lines 1202 across the areas of the manufacturing field system 100. Each production line is managed by one or more higher PLCs 1203 in the hierarchy. The higher PLCs manage one or more PLCs 1204, 1205, which manage one or more manufacturing machines 1206, 1207, 1208, 1209 that are configured to execute in some order as designated by the previous/next fields. The data entry 1203-1209 represents a diagram of assets in manufacturing field system 100. The field operator 153 can insert additional information such as 1201-1202 so that manufacturing productivity can be managed efficiently.

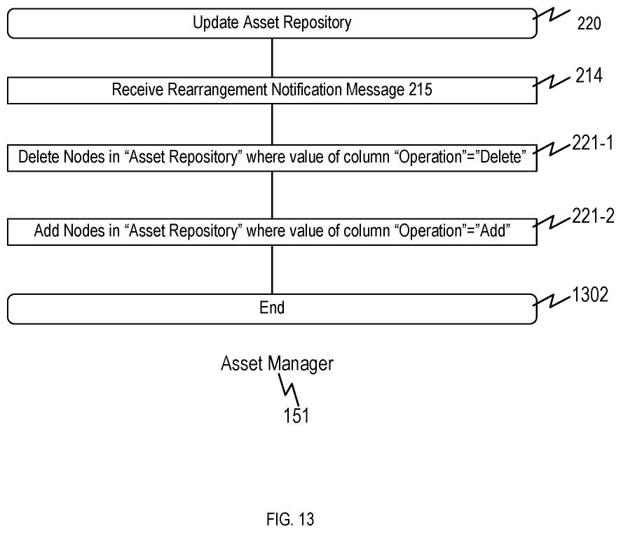

FIG. 13 illustrates an example flow process of Asset Manager 151 in accordance with an example implementation. At 214, the asset manager 151 receives the rearrangement notification message 215. At 221-1, the asset manager 151 deletes the nodes in the asset repository 152 corresponding to the values associated with the delete operation in the message. At 221-2, the asset manager 151 adds nodes in the asset repository 152 corresponding to the values associated with the add operation in the message.

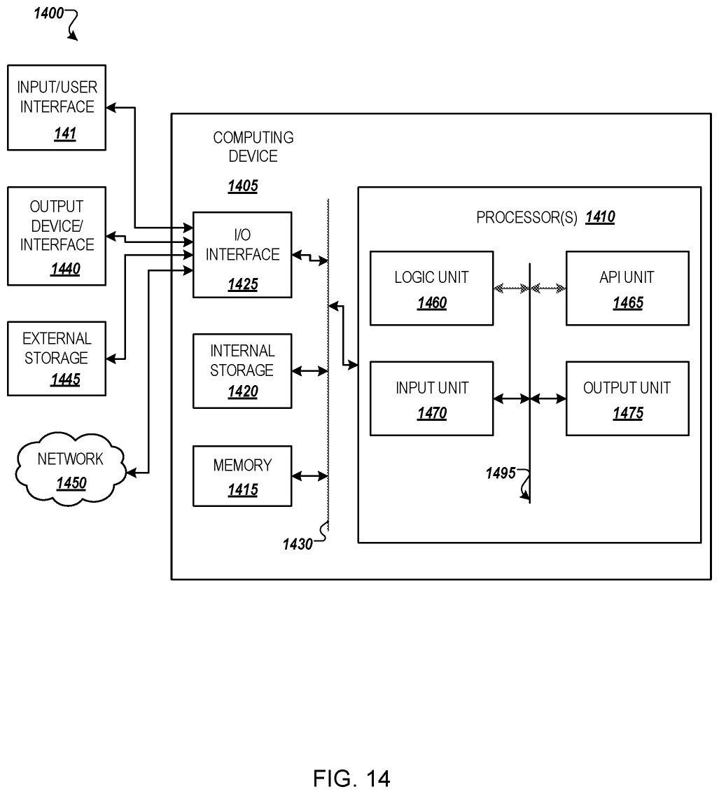

FIG. 14 illustrates an example computing environment with an example computer device suitable for use in example implementations. Computer device 1405 in computing environment 1400 can include one or more processing units, cores, or processors 1410, memory 1415 (e.g., RAM, ROM, and/or the like), internal storage 1420 (e.g., magnetic, optical, solid state storage, and/or organic), and/or I/O interface 1425, any of which can be coupled on a communication mechanism or bus 1430 for communicating information or embedded in the computer device 1405.

Computer device 1405 can be communicatively coupled to input/user interface 1435 and output device/interface 1440. Either one or both of input/user interface 1435 and output device/interface 1440 can be a wired or wireless interface and can be detachable. Input/user interface 1435 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1440 may include a display, television, monitor, printer, speaker, braille, or the like. In some example implementations, input/user interface 1435 and output device/interface 1440 can be embedded with or physically coupled to the computer device 1405. In other example implementations, other computer devices may function as or provide the functions of input/user interface 1435 and output device/interface 1440 for a computer device 1405. In example implementations involving a touch screen display, a television display, or any other form of display, the display is configured to provide a user interface.

Examples of computer device 1405 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1405 can be communicatively coupled (e.g., via I/O interface 1425) to external storage 1445 and network 1450 for communicating with any number of networked components, devices, and systems, including one or more computer devices of the same or different configuration. Computer device 1405 or any connected computer device can be functioning as, providing services of, or referred to as a server, client, thin server, general machine, special-purpose machine, or another label.

I/O interface 1425 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1400. Network 1450 can be any network or combination of networks (e.g., the Internet, local area network, wide area network, a telephonic network, a cellular network, satellite network, and the like).

Computer device 1405 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1405 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1410 can execute under any operating system (OS) (not shown), in a native or virtual environment. One or more applications can be deployed that include logic unit 1460, application programming interface (API) unit 1465, input unit 1470, output unit 1475, and inter-unit communication mechanism 1495 for the different units to communicate with each other, with the OS, and with other applications (not shown). The described units and elements can be varied in design, function, configuration, or implementation and are not limited to the descriptions provided. Processor(s) 1410 can be in the form of physical processors or central processing units (CPU) that is configured to execute instructions loaded from Memory 1415.

In some example implementations, when information or an execution instruction is received by API unit 1465, it may be communicated to one or more other units (e.g., logic unit 1460, input unit 1470, output unit 1475). In some instances, logic unit 1460 may be configured to control the information flow among the units and direct the services provided by API unit 1465, input unit 1470, output unit 1475, in some example implementations described above. For example, the flow of one or more processes or implementations may be controlled by logic unit 1460 alone or in conjunction with API unit 1465. The input unit 1470 may be configured to obtain input for the calculations described in the example implementations, and the output unit 1475 may be configured to provide output based on the calculations described in example implementations.

In an example implementation, the computer device 1405 is an apparatus such as rearrangement detect server 130 configured for detecting changes in a manufacturing field system 100 with a first network processing data regarding one or more manufacturing machines 117-1, 117-2, and a second network managing a plurality of programmable logic controllers (PLCs) 116-1, 116-2 connected to the one or more manufacturing machines 117-1, 117-2. In an example implementation, such an apparatus is communicatively coupled to the second network.

In such an example implementation, processor(s) 1410 can be configured to facilitate the functionality of rearrangement detector 131 and behavior monitor 132 with its corresponding elements, and memory 1415 can be configured to facilitate the functionality of monitoring repositories 141 with their corresponding elements and arrangement pattern repository 140 from FIG. 1. In an example implementation, processor(s) 1410 can be configured to monitor the plurality of PLCs through the second network, each of the PLCs associated with the one or more manufacturing machines through the execution of the process 200 in FIG. 2; and for the monitoring indicating a change in the second network, the change involving one or more of a different manufacturing machine associated with one of the plurality of PLCs, or a change in an order of execution of the one or more manufacturing machines for one of the plurality of PLCs, update a hierarchy of the manufacturing field system based on the change through the execution of the process 210 in FIG. 2.

In an example implementation, processor(s) 1410 can be configured to update the internal hierarchy of the manufacturing field system by providing a message to update a status of the manufacturing field system, the message involving instructions to add or delete information to the internal hierarchy of the manufacturing field system as illustrated in FIG. 10, process 214-1, 214-2, and FIGS. 11(a) and 11(b), wherein the first network processes data in accordance to the status of the manufacturing field system as illustrated in FIG. 13.

In an example implementation, processor(s) 1410 can be configured to monitor the plurality of PLCs through the second network by monitoring PLC status behavior through issuing an object identifier get request to the plurality of PLCs; processing from a response to the object identifier get request, information associated with identifiers of the plurality of PLCs and the one or more manufacturing machines; and for the information associated with identifiers of the plurality of PLCs and the one or more manufacturing machines comprising new information in comparison to a repository of information regarding PLC status behavior, updating the repository of information regarding PLC status behavior with the information associated with identifiers of the plurality of PLCs and the one or more manufacturing machines as illustrated in FIGS. 3 and 4.

In an example implementation, processor(s) 1410 can be configured to monitor the plurality of PLCs through the second network by processing a deep packet inspection (DPI) stream from a networking device managing the one or more PLCs for one or more features and one or more periodic sequences associated with communications between the plurality of PLCs and a higher PLC configured to manage the plurality of PLCs; and for the one or more features or the one or more periodic sequences involving new information in comparison to a repository of features and periodic sequences, updating the repository of the features and the periodic sequences with the one or more features or the one or more periodic sequences involving new information as illustrated in FIGS. 5 and 6.

In an example implementation, processor(s) 1410 can be configured to monitor the plurality of PLCs through the second network by monitoring network behavior through issuing an object identifier get request to a networking device managing the plurality of PLCs; processing from a response to the object identifier get request, information associated with throughput between one or more of the plurality of PLCs and a higher PLC managing the plurality of PLCs; and for the information associated with throughput involving new information in comparison to a repository of information regarding network behavior, updating the repository of information regarding network behavior with the information associated with the throughput as illustrated in FIGS. 7 and 8.

In an example implementation, processor(s) 1410 can be configured to determine whether the monitoring indicates a change, by for first values associated with the one or more manufacturing machines, the plurality of PLCs or a higher PLC managing the plurality of PLCs from the monitoring (as obtained from the process of 211 of FIG. 10) being different from second values associated with the one or more manufacturing machines (as obtained from the process of 212 of FIG. 10), the plurality of PLCs, or the higher PLC from a repository managing an arrangement pattern of the manufacturing field systems, determining that the monitoring indicates a change as illustrated in FIGS. 9 and 10.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for detecting changes in a manufacturing field system comprising a first network processing data regarding one or more manufacturing machines, and a second network managing a plurality of programmable logic controllers (PLCs) connected to the one or more manufacturing machines, the method comprising:
monitoring the plurality of PLCs through the second network, each of the PLCs associated with the one or more manufacturing machines; and
for the monitoring indicating a change in the second network, the change comprising one or more of a different manufacturing machine associated with one of the plurality of PLCs, or a change in an order of execution of the one or more manufacturing machines for one of the plurality of PLCs, updating a hierarchy of the manufacturing field system based on the change.

2. The method of claim 1, wherein the updating the hierarchy of the manufacturing field system comprises providing a message to update a status of the manufacturing field system, the message comprising instructions to add or delete information to the hierarchy of the manufacturing field system, wherein the first network processes data in accordance to the status of the manufacturing field system.

3. The method of claim 1, wherein the monitoring the plurality of PLCs through the second network comprises:
monitoring PLC status behavior through issuing an object identifier get request to the plurality of PLCs;
processing from a response to the object identifier get request, information associated with identifiers of the plurality of PLCs and the one or more manufacturing machines; and
for the information associated with identifiers of the plurality of PLCs and the one or more manufacturing machines comprising new information in comparison to a repository of information regarding PLC status behavior, updating the repository of information regarding PLC status behavior with the information associated with identifiers of the plurality of PLCs and the one or more manufacturing machines.

4. The method of claim 1, wherein the monitoring the plurality of PLCs through the second network comprises:
processing a deep packet inspection (DPI) stream from a networking device managing the one or more PLCs for one or more features and one or more periodic sequences associated with communications between the plurality of PLCs and a higher PLC configured to manage the plurality of PLCs;
for the one or more features or the one or more periodic sequences comprising new information in comparison to a repository of features and periodic sequences, updating the repository of the features and the periodic sequences with the one or more features or the one or more periodic sequences comprising new information.

5. The method of claim 1, wherein the monitoring the plurality of PLCs through the second network comprises:
monitoring network behavior through issuing an object identifier get request to a networking device managing the plurality of PLCs;
processing from a response to the object identifier get request, information associated with throughput between one or more of the plurality of PLCs and a higher PLC managing the plurality of PLCs; and
for the information associated with throughput comprising new information in comparison to a repository of information regarding network behavior, updating the repository of information regarding network behavior with the information associated with the throughput.

6. The method of claim 1, further comprising determining whether the monitoring indicates a change, the determining comprising:
for first values associated with the one or more manufacturing machines, the plurality of PLCs or a higher PLC managing the plurality of PLCs from the monitoring being different from second values associated with the one or more manufacturing machines, the plurality of PLCs, or the higher PLC from a repository managing an arrangement pattern of the manufacturing field systems, determining that the monitoring indicates a change.

7. A non-transitory computer readable medium, storing instructions for detecting changes in a manufacturing field system comprising a first network processing data regarding one or more manufacturing machines, and a second network managing a plurality of programmable logic controllers (PLCs) connected to the one or more manufacturing machines, the method comprising:
monitoring the plurality of PLCs through the second network, each of the PLCs associated with the one or more manufacturing machines; and
for the monitoring indicating a change in the second network, the change comprising one or more of a different manufacturing machine associated with one of the plurality of PLCs, or a change in an order of execution of the one or more manufacturing machines for one of the plurality of PLCs, updating a hierarchy of the manufacturing field system based on the change.

8. The non-transitory computer readable medium of claim 7, wherein the updating the hierarchy of the manufacturing field system comprises providing a message to update a status of the manufacturing field system, the message comprising instructions to add or delete information to the hierarchy of the manufacturing field system, wherein the first network processes data in accordance to the status of the manufacturing field system.

9. The non-transitory computer readable medium of claim 7, wherein the monitoring the plurality of PLCs through the second network comprises:
monitoring PLC status behavior through issuing an object identifier get request to the plurality of PLCs;
processing from a response to the object identifier get request, information associated with identifiers of the plurality of PLCs and the one or more manufacturing machines; and
for the information associated with identifiers of the plurality of PLCs and the one or more manufacturing machines comprising new information in comparison to a repository of information regarding PLC status behavior, updating the repository of information regarding PLC status behavior with the information associated with identifiers of the plurality of PLCs and the one or more manufacturing machines.

10. The non-transitory computer readable medium of claim 7, wherein the monitoring the plurality of PLCs through the second network comprises:
processing a deep packet inspection (DPI) stream from a networking device managing the one or more PLCs for one or more features and one or more periodic sequences associated with communications between the plurality of PLCs and a higher PLC configured to manage the plurality of PLCs;
for the one or more features or the one or more periodic sequences comprising new information in comparison to a repository of features and periodic sequences, updating the repository of the features and the periodic sequences with the one or more features or the one or more periodic sequences comprising new information.

11. The non-transitory computer readable medium of claim 7, wherein the monitoring the plurality of PLCs through the second network comprises:
monitoring network behavior through issuing an object identifier get request to a networking device managing the plurality of PLCs;
processing from a response to the object identifier get request, information associated with throughput between one or more of the plurality of PLCs and a higher PLC managing the plurality of PLCs; and
for the information associated with throughput comprising new information in comparison to a repository of information regarding network behavior, updating the repository of information regarding network behavior with the information associated with the throughput.

12. The non-transitory computer readable medium of claim 7, the instructions further comprising determining whether the monitoring indicates a change, the determining comprising:
for first values associated with the one or more manufacturing machines, the plurality of PLCs or a higher PLC managing the plurality of PLCs from the monitoring being different from second values associated with the one or more manufacturing machines, the plurality of PLCs, or the higher PLC from a repository managing an arrangement pattern of the manufacturing field systems, determining that the monitoring indicates a change.

13. An apparatus configured for detecting changes in a manufacturing field system comprising a first network processing data regarding one or more manufacturing machines, and a second network managing a plurality of programmable logic controllers (PLCs) connected to the one or more manufacturing machines, the apparatus communicatively coupled to the second network, the apparatus comprising:
a processor, configured to:
monitor the plurality of PLCs through the second network, each of the PLCs associated with the one or more manufacturing machines; and
for the monitoring indicating a change in the second network, the change comprising one or more of a different manufacturing machine associated with one of the plurality of PLCs, or a change in an order of execution of the one or more manufacturing machines for one of the plurality of PLCs, update a hierarchy of the manufacturing field system based on the change.

14. The apparatus of claim 13, wherein the processor is configured to update the hierarchy of the manufacturing field system by providing a message to update a status of the manufacturing field system, the message comprising instructions to add or delete information to the hierarchy of the manufacturing field system, wherein the first network processes data in accordance to the status of the manufacturing field system.

15. The apparatus of claim 13, wherein the processor is configured to monitor the plurality of PLCs through the second network by:
monitoring PLC status behavior through issuing an object identifier get request to the plurality of PLCs;
processing from a response to the object identifier get request, information associated with identifiers of the plurality of PLCs and the one or more manufacturing machines; and
for the information associated with identifiers of the plurality of PLCs and the one or more manufacturing machines comprising new information in comparison to a repository of information regarding PLC status behavior, updating the repository of information regarding PLC status behavior with the information associated with identifiers of the plurality of PLCs and the one or more manufacturing machines.

16. The apparatus of claim 13, wherein the processor is configured to monitor the plurality of PLCs through the second network by:
processing a deep packet inspection (DPI) stream from a networking device managing the one or more PLCs for one or more features and one or more periodic sequences associated with communications between the plurality of PLCs and a higher PLC configured to manage the plurality of PLCs;
for the one or more features or the one or more periodic sequences comprising new information in comparison to a repository of features and periodic sequences, updating the repository of the features and the periodic sequences with the one or more features or the one or more periodic sequences comprising new information.

17. The apparatus of claim 13, wherein the processor is configured to monitor the plurality of PLCs through the second network by:
monitoring network behavior through issuing an object identifier get request to a networking device managing the plurality of PLCs;
processing from a response to the object identifier get request, information associated with throughput between one or more of the plurality of PLCs and a higher PLC managing the plurality of PLCs; and
for the information associated with throughput comprising new information in comparison to a repository of information regarding network behavior, updating the repository of information regarding network behavior with the information associated with the throughput.

18. The apparatus of claim 13, wherein the processor is further configured to determine whether the monitoring indicates a change, by:
for first values associated with the one or more manufacturing machines, the plurality of PLCs or a higher PLC managing the plurality of PLCs from the monitoring being different from second values associated with the one or more manufacturing machines, the plurality of PLCs, or the higher PLC from a repository managing an arrangement pattern of the manufacturing field systems, determining that the monitoring indicates a change.
